(19) United States
(12) Patent Application Publication
(10) Pub. No.: US 2003/0227904 A1
(43) Pub. Date: Dec. 11, 2003

(54) Associating virtual channel identifier to a user phone number at an access node in a VoATM telecommunication system

(75) Inventors: Michael Rabinovich, Modiin (IL); Matia Marcu, Natanya (IL); Boris Pruss, Rosh Ain (IL); Oleg Sher, Givataim (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/165,076

(22) Filed: Jun. 6, 2002

(51) Int. Cl. H04L 12/66; H04L 12/28

(52) U.S. Cl. 370/352; 370/395.1

(57) ABSTRACT

Identifying virtual connection to telephony port relations in a telecommunication system. In one embodiment, a database is compiled of associations of virtual customer identity (VCID) information from ATM cells to telephony ports in an access system. The database is compiled by sending calling line identification presentation (CLIP) information across an ATM network along with the VCID to a virtual identification line (VIL) port in the access system. Reading the CLIP information associated with the VCID and storing VCID to telephony port relations in the database based on the CLIP information.

### TECHNICAL FIELD

The present invention relates generally to the field of data communications or telecommunications and, in particular, identifying virtual connection to telephony port relations over a VoATM telecommunication system.

### BACKGROUND

The modem telephone system was primarily designed to transport voice signals between terminals at remote locations. Conventionally, the telephone system makes connections and routes calls through a network using switches and other electronic equipment. Prior to the 1960s, the telephone system used primarily analog switches and other analog equipment. With the increasing capability of computer systems and other digital electronics, the telephone system began to include digital switches and other equipment. For example, Digital Loop Carriers (DLCs) were developed to allow connections from a number of subscribers to be routed to a location remote from the central office and then connected to the central office over a high speed, digital line. Again, however, this digital equipment was primarily designed to handle voice signals.

Over time, telecommunications systems have been used to carry data, other than voice signals, between terminals at remote locations as well. Transporting data has posed a variety of problems for conventional telephone systems. For example, as mentioned, the telephone system was designed to carry low bandwidth voice traffic. Unfortunately, these low bandwidth channels can provide a significant obstacle to providing higher bandwidth data services that have become so popular, e.g., the Internet and other data networks.

To capture a portion of this data market, the telephony industry developed a group of technologies known collectively as “Digital Subscriber Line” (DSL) services, e.g., Asymmetrical Digital Subscriber Line (ADSL), High-Bit Rate Digital Subscriber Line (HDSL), Rate Adaptive Digital Subscriber Line (RADSL), Symmetric Digital Subscriber Line (SDSL), etc. These services provide high speed connections over existing copper wires used to carry conventional telephone traffic. These services use various modulation schemes and other techniques to allow the data to be transmitted over the existing copper lines at higher speeds. In addition to data, some of these DSL technologies allow multiple phone lines to share one physical line thus increasing the capacity of the system without the need to install additional copper connections between the customer and the network.

Unfortunately, DSL voice traffic is not directly compatible with conventional equipment in the Public Switched Telephone Network (PSTN). For example, DSL voice traffic conventionally is incorporated in Asynchronous Transfer Mode (ATM) packets or cells. This is different from the Time Division Multiplexing (TDM) format associated with the PSTN. Further, the ATM packets are not directly compatible with signaling and other requirements of the PSTN. Therefore, a specialized voice gateway is placed at the point in the network that DSL voice traffic, e.g., from a number of DLCs, is to enter the PSTN. This voice gateway provides translation between ATM and TDM formats as well as processing the signaling and other functions required by network standards, e.g., GR-303 in North America, V5 in the International market, to prepare the voice traffic for transmission over the PSTN.

One problem with this architecture is that the ATM to PSTN interface introduces difficulties in locating ATM to PSTN connections when trouble shooting problems in the system. This is difficult because one part of a telecommunication system is located at a different physical location than another part of the telecommunication system and the different parts of the telecommunication system are typically owned by different entities. Accordingly, there is a need in the art for an efficient method of locating ATM to PSTN connections.

For the reasons stated above, and for other reasons stated below which will become apparent to those skilled in the art upon reading and understanding the present specification, there is a need in the art for an efficient method of locating ATM to PSTN connections.

### SUMMARY

The above-mentioned problems and other problems are addressed by embodiments of the present invention and will be understood by reading and studying the following description.

In one embodiment, a method of compiling a database of associations of virtual customer identity (VCID) information from ATM cells to telephony ports in an access system is disclosed. The method comprises sending calling line identification presentation (CLIP) information across the ATM network along with the VCID to a virtual identification line (VIL) port in the access system. Reading the CLIP information associated with the VCID and storing VCID to telephony port relations in the database based on the CLIP information.

In another embodiment, another method of compiling a database of associations of virtual customer identity (VCID) information from ATM cells to telephony ports in an access system is disclosed. The method comprises receiving an input signal request to store a VCID to telephony port relation in the database. Blocking the telephony port that uses the VCID to prevent an associated end user from accessing the telephony port. Initiating a first call using the VCID to a virtual identification line (VIL) port in the access system. Sending ATM cells containing the VCID and VIL information across an ATM network to an access gateway. Establishing a second call with the access gateway. Sending ring and calling line identification presentation (CLIP) information across the ATM network to the VIL port. Recognizing the calling number associated with a telephony port in the CLIP information and storing a VCID to telephony port relation in the database.

In another embodiment, an access system device is disclosed. The access system device comprises a network port, a plurality of telephony ports, a translation circuit, virtual identification line (VIL) port, a database and an associated function. The network port is coupled to an asynchronous transfer mode (ATM) network to interface ATM signals from an ATM network. Each telephony port is coupled to subscriber equipment and interfaces time division multiplexing (TDM) signals to the subscriber equipment. The translation circuit is coupled between the plurality of telephony ports and the network port to provide translation between the ATM and TDM signal formats. The virtual identification line (VIL) port is coupled to the translation circuit and is adapted to receive calling line identification presentation (CLIP) information over the ATM network. The database is used to store VCID to telephony port relations that are determined with the CLIP information. Moreover, the associated function is adapted to control VCID to telephony port relation functions.

In another embodiment, a communication system is disclosed. The communication system includes a local exchange, an access gateway, an ATM network and an access system. The local exchange has a calling line identification presentation (CLIP) function to provide CLIP services. The access gateway is adapted to translate between time division signals (TDM) signals and asynchronous transfer mode (ATM) signals. Moreover, the access gateway is coupled between the local exchange and the ATM network. The access system comprises a network port, a plurality of telephony ports, a translation circuit, virtual identification line (VIL) port, a database and an associated function. The network port is coupled to the ATM network to interface ATM signals from an ATM network. Each telephony port is coupled to subscriber equipment and interfaces time division multiplexing (TDM) signals to the subscriber equipment. The translation circuit is coupled between the plurality of telephony ports and the network port to provide translation between the ATM and TDM signal formats. The virtual identification line (VIL) port is coupled to the translation circuit and is adapted to receive calling line identification presentation (CLIP) information over the ATM network. The database is used to store VCID to telephony port relations that are determined with the CLIP information. Moreover, the associated function is adapted to control VCID to telephony port relation functions.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a communication system of the prior art;

FIG. 2 is a block diagram of one embodiment of a communication system of the present invention;

FIG. 3 is a block diagram of another embodiment of the a communication of the present invention; and

FIG. 4 is a flow chart illustrating one method of using the present invneiton.

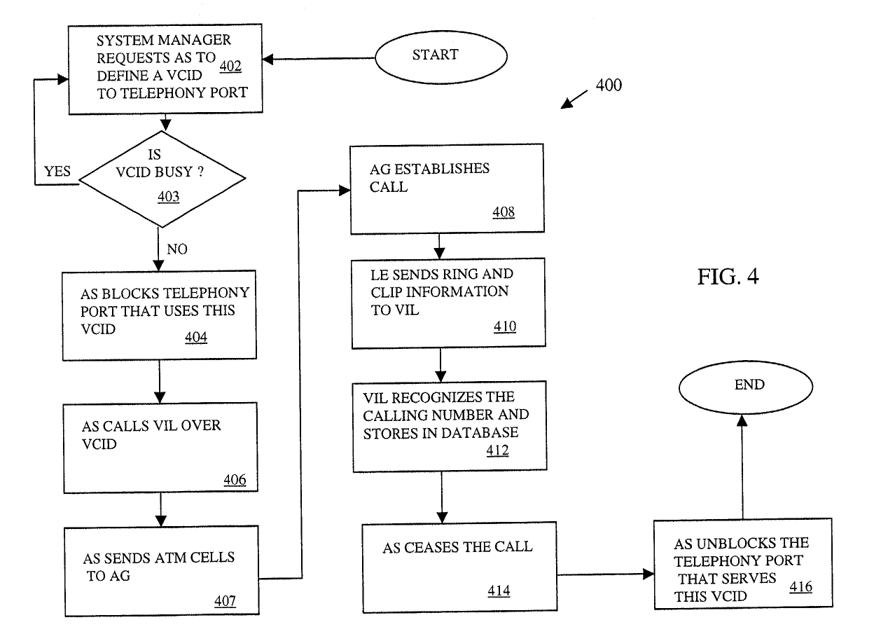

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

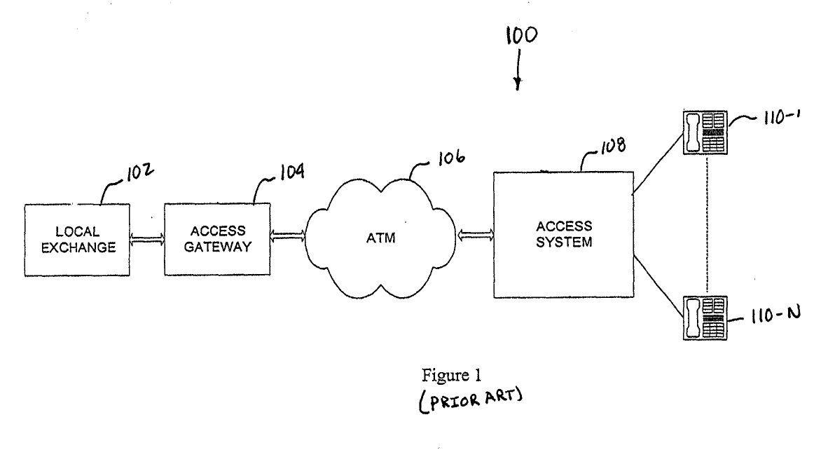

Various embodiments of the present invention provide a method of creating a database of associated telephony port to ATM identifier signals to aid during trouble shooting procedures. Before a detailed description of the invention is given, further background is first provided to aid in the understanding of the present invention. Referring to FIG. 1, an example of a voice over asynchronous transfer mode loop emulation service (VoATM LES) system 100 of the prior art is illustrated. As illustrated, the system 100 provides communications between subscriber equipment 110-1 to 110-N and local exchange (LE) 102. In one embodiment of the prior art, the LE 102 is a class 5 switch with either V5.x or GR303 access interfaces. The access gateway (AG) 104 interfaces the local exchange 102, e.g., the PSTN, with the asynchronous transfer mode (ATM) network 106. That is, the AG 104 converts PSTN voice and signaling information from the LE 102 into asynchronous transfer mode adaptive layer 2 (ATM AAL2) cells and vice versa according to VoATM LES specifications. As illustrated, theses cells are transmitted between the AG 104 and the access system (AS) 108 via the ATM network 106. The AS 108 converts the ATM AAL2 cells into PSTN voice and signaling information and vice versa. The AS 108 is coupled to subscriber equipment 110-1 to 110-N. The AS 108 may be an integrated multiservice access platform (IMAP) or combination of a digital subscriber line access multiplexer (DSLAM) and integrated access device (LAD).

Each ATM AAL2 cell includes identifiers to track signals. For example, the identifiers typically include a virtual path identifier (VPI), a virtual channel identifier (VCI) and a channel identifier (CID). The VPI is typically an eight bit field in the ATM cell header that indicates the virtual path over which the cell is to be routed. The VCI is typically a 16 bit field in the ATM cell header that identifies the virtual channel over which a stream of cells is to travel during the course of a session between devices. The CID is a single record containing fields of customer information associated with a single customer. The identifiers VIP, VCI and CID can be commonly referred to as the VCID. Accordingly, each ATM AAL2 cell (or ATM cell) has VCID bits that provide routing information in its header that are predefined by an operator of the system.

During trouble shooting procedures of the prior art, the service provider of the AS 108 typically does not have explicit information regarding the relation between telephony ports that interface end user phone numbers and associated VCIDs in ATM cells. This hampers the ability to trouble shoot problems especially considering that the LE 102 and the AS 108 are typically in different physical locations and may be owned and operated by different entities. Embodiments of the present invention provide a method of automatically obtaining the relationship between a VCID and an associated end user telephony port and storing this information in the access network without operator input.

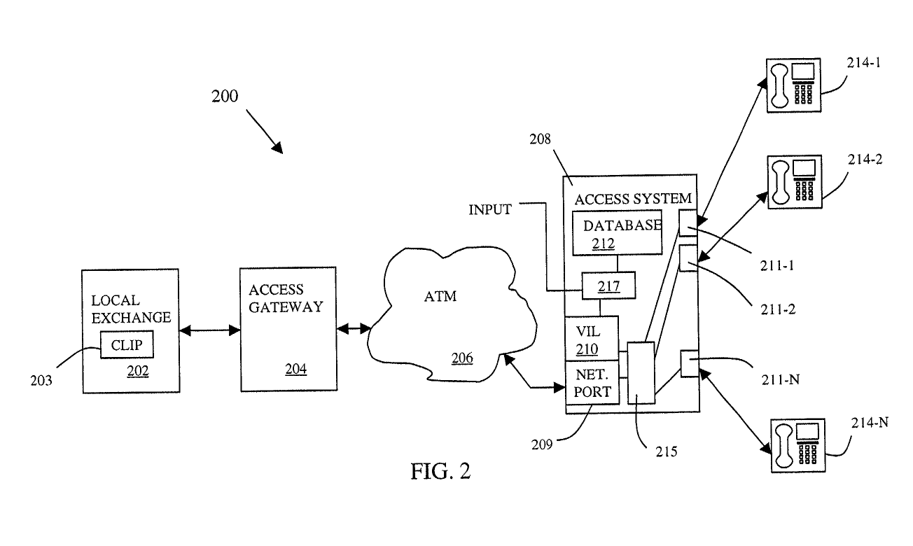

Referring to FIG. 2, one embodiment of a communication system 200 of the present invention is illustrated. As illustrated, this embodiment includes LE 202, an AG 204, ATM network 206, AS 208 and subscriber equipment 124-1 to 124-N. The local exchange 202 includes a function 203 that provides calling line identification presentation (CLIP) service. It will be understood in the art that LE 202 can support other types of services that provide information similar to the CLIP service. In fact, any service that provides a phone numbers could be used in place of the CLIP service. Accordingly, the present invention is not limited to the LE 202 using CLIP service.

The AS 208 of this embodiment is illustrated as having a network port 209, a translation circuit 215, an association function 217, a virtual identification line (VIL) port 210, a database 212 and a plurality of telephony ports 211 (1−N). As illustrated in FIG. 2, each telephony port 211(1−N) is coupled to an associated subscriber equipment 214 (1−N). The translation circuit 215 of the AS 208 provides a translation connection between the ATM cells of the ATM network 206 at the network port 209 and the PSTN signals at telephony ports 214 (1−N). The VIL port 210 acts like a user port and has the ability to terminate VOATM LES calls. The VIL 210 further has the ability to support calling line identification presentation (CLIP) information. The association function 217 of the AS 208 controls functions required to store VCID to telephony port relations. In one embodiment, the association function 217 is software and in another embodiment the association function 217 is hardware. The association function 217 initiates functions to store VCID to telephony port relations in response to an input from a service provider. The AS 208 of this embodiment is adapted to retrieve VCID to telephony port relations after establishing the VOATM LES. In use, each VCID to telephony port relation is stored in database 212 for use by the service provider during troubling shooting procedures.

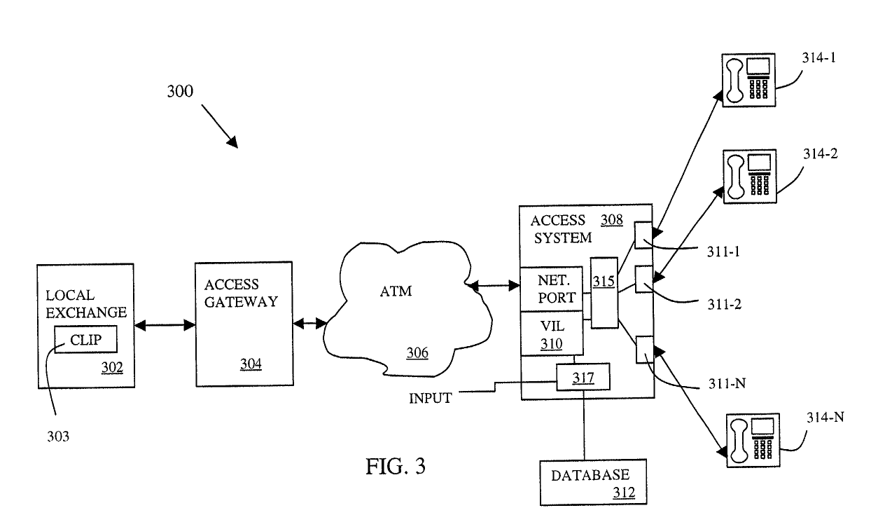

As illustrated in FIG. 2, the database 212 is located in the AS 208 in this embodiment. Another embodiment of a communication system 300, of the present invention, is illustrated in FIG. 3. This embodiment includes LE 302, AG 304, ATM 306, AS 308, translation circuit 215, association function 317, database 312, telephony ports 311 (1−N) and subscriber equipment 314 (1−N). The LE 302 includes function 303 that provides CLIP service. The AS 308 further includes VIL PORT 310, network port 309 and telephony ports 311 (1−N). The embodiment of FIG. 3 works similar to the embodiment of FIG. 2, except the database 312 can be located in a remote location outside the AS 308.

A flow chart 400 illustrating one method of the present invention. The method starts by the system manager requesting the AS to define VCID to telephony port relations (402). In one embodiment, this is done by sending an input signal to an association function of the AS. In one embodiment, each VCID to telephony port relation is defined by a separate input signal request. In another embodiment, a single input signal request from a system manager causes the AS to automatically define each VICD to telephony port relationship. Once a request has been received by the AS, the As determines if the VCID is currently in use (403). If the VCID is currently in use (the end user is currently using his or her telephone), the system manager is informed by a busy signal and the method once again waits for the system manager to request the AS to define a VCID to telephony port relation (420). In another embodiment, the AS waits until the VCID is no longer in use and then proceeds with the method as illustrated in flow chart 400.

Once, a request has been received and the VCID in question is determined to not be busy, the AS blocks the telephony port that uses this VCID (404). The associated telephony port is blocked to prevent an end user coupled to the associated telephony port from placing a call during the process. This could seize the line causing the process to be interrupted. The AS then initiates a call using the VCID to the VIL port (406). This includes sending an off hook signal and dialed VIL number information. The actions of the AS at block (406) simulate a user assigned to this VCID picking up the hand set and dialing the VIL number. The AS then sends ATM cells to the AG across the ATM network (407). The ATM cells include VCID, off hook signal and VIL number information. The AG processes the ATM cells and establishes a call with a LE (408). That is, the AG, receives the signaling cells from the VIL and establishes a call with the LE based on the subscriber associated with the VCID and the VIL.

As a result of the AG establishing the call at block (408), the LE sends ring and CLIP information to the VIL through the ATM network (410). In this embodiment, the VIL is defined as a port that requires CLIP information. The CLIP information in one embodiment is sent by the LE between the first and second ring signals. The VIL recognizes the calling number in the CLIP information and stores the calling number to telephony port relation into the database (412). The calling number is actually the phone number that is associated with the telephony port served via the explored VCID. Accordingly, the calling number to telephony port relationship is the VCID to telephony port relation. After the VCID to telephony relation is stored in the database, the AS ceases the call (414) and unblocks the associated telephony port to allow the end user normal telephone service. Thereafter the service provider can retrieve the VCID to telephony port relations from the database during troubleshooting operations.

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. Therefore, it is intended that this invention be limited only by the claims and the equivalents thereof.

What is claimed is:

1. A method of compiling a database of associations of virtual customer identity (VCID) information from ATM cells to telephony ports in an access system; the method comprising:
sending calling line identification presentation (CLIP) information across the ATM network along with the VCID to a virtual identification line (VIL) port in the access system;
reading the CLIP information associated with the VCID; and
storing VCID to telephony port relations in the database based on the CLIP information.

2. The method of claim 1, further comprising:
receiving a request to determine the VCID to telephony port relation at the access system through the VCID;
initiating a call to the VIL port using the VCID information in the access system, wherein the call includes off-hook and dialed number information;
sending signaling bits to an access gateway using the VCID;
establishing a call with the access gateway;
attaching CLIP information to the VCID cells at a local exchange; and
sending the VCID cells with the associated CLIP information to the VIL port.

3. The method of claim 1, further comprising:
blocking the telephony port which is associated with the VCID, while the VCID to telephony port telephony relation is being recorded in the database; and
unblocking the telephony port which is associated with the VCID, once the VCID to telephony port has been recorded in the database.

4. The method of claim 1, further comprising:
sending on-hook signaling cell on the VCID to the local exchange, once the VCID to telephony port has been recorded, wherein the call is ended.

5. A method of compiling a database of associations of virtual customer identity (VCID) information from ATM cells to telephony ports in an access system; the method comprising:
receiving an input signal request to store a VCID to telephony port relation in the database;
blocking the telephony port that uses the VCID to prevent an associated end user from accessing the telephony port;
initiating a call using the VCID to a virtual identification line (VIL) port in the access system;
sending ATM cells containing the VCID and VIL information across an ATM network to an access gateway;
processing the ATM cells with the access gateway;
establishing the call with a local exchange;
sending ring and calling line identification presentation (CLIP) information across the ATM network to the VIL port;
recognizing the calling number associated with a telephony port in the CLIP information; and
storing a VCID to telephony port relation in the database.

6. The method of claim 5, further including:
determining if the VCID is currently in use prior to blocking the telephony port that uses the VCID to prevent an associated end user from accessing the telephony port; and
when in use, sending a busing signal.

7. The method of claim 5, further including:
determining if the VCID is currently in use prior to blocking the telephony port that uses the VCID to prevent an associated end user from accessing the telephony port; and
when in use, waiting unit the VCID is no longer in use.

8. The method of claim 5, further comprising:
ceasing the call once the VCID to telephony port relation is stored in the database; and
unblocking the telephony port that serves the VCID.

9. The method of claim 5, wherein the initiated first call includes off hook signal and dialed VIL number information.

10. An access system device comprising:
a network port coupled to an asynchronous transfer mode (ATM) network to interface ATM signals from an ATM network;
a plurality of telephony ports, each telephony port is coupled to subscriber equipment, wherein the each telephony port interfaces time division multiplexing (TDM) signals to the subscriber equipment;
a translation circuit coupled between the plurality of telephony ports and the network port to provide translation between the ATM and TDM signal formats;
a virtual identification line (VIL) port coupled to the translation circuit and adapted to receive calling line identification presentation (CLIP) information over the ATM network;
a database to store VCID to telephony port relations that are determined with the CLIP information; and
an associated function adapted to control VCID to telephony port relation functions.

11. The access system device of claim 10, wherein the VIL port is adapted to terminate calls.

12. The access system device of claim 10, wherein the access system is an integrated multi-service access platform.

13. The access system device of claim 10, wherein the access device further comprises:
a digital subscriber line access multiplexer (DSLAM); and
an integrated access device (IAD).

14. The access system device of claim 10, wherein the association function is adapted to control the determination of a single VCID to telephony port relation in response to an input signal.

15. The access system device of claim 10, wherein the association function is adapted to control the determination of each VCID to telephony port relation in response to a single input signal.

16. A communication system comprising:
a local exchange having a calling line identification presentation (CLIP) function to provide CLIP services;
an access gateway adapted translate between time division signals (TDM) signals and asynchronous transfer mode (ATM) signals;
an ATM network, the access gateway is coupled between the local exchange and the ATM network; and
an access system comprising,
a network port coupled to an asynchronous transfer mode (ATM) network to interface ATM signals from the ATM network,
a plurality of telephony ports, each telephony port is coupled to subscriber equipment, wherein each telephony port interfaces time division multiplexing (TDM) signals to the subscriber equipment,
a translation circuit coupled between the plurality of telephony ports and the network port to provide translation between the ATM and TDM signal formats,
a virtual identification line (VIL) port coupled to the translation circuit and adapted to receive calling line identification presentation (CLIP) information over the ATM network,
a database to store VCID to telephony port relations that are determined with the CLIP information, and
an associated function adapted to control VCID to telephony port relation functions.

17. The communication system of claim 16, wherein the database is located in the access system.

18. The communication system of claim 16, wherein the data base in located outside the access system.

19. The communication system of claim 16, wherein the access system is an integrated multi-service access platform.

20. The communication system of claim 16, wherein the access device further comprises:
a digital subscriber line access multiplexer (DSLAM); and
an integrated access device (LAD).

21. The communication system of claim 16, wherein the VIL port of the access system is adapted to terminate calls.

22. The access system device of claim 16, wherein the association function is adapted to control the determination of a single VCID to telephony port relation in response to an input signal.

23. The access system device of claim 16, wherein the association function is adapted to control the determination of each VCID to telephony port relation in response to a single input signal.
